(19) United States
(12) Patent Application Publication
(10) Pub. No.: US 2016/0343143 A1
(43) Pub. Date: Nov. 24, 2016

(54) EDGE DETECTION APPARATUS, EDGE DETECTION METHOD, AND COMPUTER READABLE MEDIUM

(71) Applicant: MITSUBISHI ELECTRIC CORPORATION, Tokyo (JP)

(72) Inventors: Takahiro KASHIMA, Tokyo (JP); Naoyuki TSUSHIMA, Tokyo (JP)

(73) Assignee: MITSUBISHI ELECTRIC CORPORATION, Tokyo (JP)

(21) Appl. No.: 15/112,787

(22) PCT Filed: Mar. 5, 2014
(86) PCT No.: PCT/JP2014/001209

§ 371 Date: Jul. 20, 2016

(51) Int. Cl. G06T 7/00; G06T 5/00

(52) U.S. Cl. CPC G06T 7/0085; G06T 5/002; G06T 2207/10024; G06T 2207/20056

(57) ABSTRACT

The present invention provides an edge detection apparatus, an edge detection method, and a program that are capable of improving the rate of detection of edges for edges having small variations in image information in an image.

The edge detection apparatus includes a first processing unit that obtains a variation direction of a pixel value in a first pixel block, using pixel values of a plurality of pixels in a first local region including the first pixel block;

a second processing unit that obtains a variation direction of a pixel value in a second pixel block which is different from the first pixel block, using pixel values of a plurality of pixels in a second local region including the second pixel block; and

a third processing unit that determines that the first pixel block is an edge if a difference between the variation direction of the pixel value at a pixel in the first pixel block and the variation direction of the pixel value at a pixel in the second pixel block is greater than or equal to a reference value.

### TECHNICAL FIELD

The present invention relates generally to an image processing technology, and relates in particular to an edge detection technology for an image.

### BACKGROUND ART

There are various known technologies in which edge detection is performed on a two-dimensional image acquired from an imaging apparatus such as a camera, and information on detected edges is applied to detect a particular object in the image (to be hereinafter described as an object; for example, a structure shown in a photographed image).

For example, there has been disclosed an augmented reality (AR) technology in which by obtaining a region of an object (construction) in an image based on information on detected edges, and further performing pattern matching between a three-dimensional map and each region in the image, each object (construction) is identified and attribute information of each structure is displayed. (Patent Literature 1)

There has also been disclosed a method for generating a three-dimensional model of an object (structure) by performing edge detection on an image to detect edges of the object (structure) and a vanishing point of the edges. (Patent Literature 2)

### CITATION LIST

### Patent Literature

Patent Literature 1: JP 11-057206 A

Patent Literature 2: JP 4964801 B

In such an applied technology using edge detection as described above, it is important to detect edges of an object appropriately.

For example, the Canny method and the Laplacian method are known as existing edge detection methods.

In these edge detection techniques, an edge is detected by performing a derivative (differential) process on an image (image information). Specifically, gradients are obtained by performing the derivative (differential) process on the image information, and an edge is detected from the obtained gradient values.

FIG. 1 is a drawing illustrating an overview of an edge detection process flow by the Canny method which is an existing technique.

In the drawing, 11 indicates a noise removal process, 12 indicates a gradient determination process, and 13 indicates a binarization process. The top of the drawing indicates the start of the process flow, and the bottom indicates the end of the process flow.

In the Canny method, the noise removal process is performed first in order to remove noise in an image. (Step 11)

Various methods can be applied as a method for noise removal. For example, noise can be removed by applying what is known as a blurring process using a Gaussian filter.

Then, with regard to a pixel to be looked at (to be hereinafter described as a pixel of interest) in the image, a gradient of a luminance value of the pixel of interest is obtained using the luminance value of the pixel of interest and a luminance value of a pixel located around the pixel of interest (to be hereinafter described as a surrounding pixel). (Step 12)

The gradient is obtained by performing a sum-of-products operation on a region including the pixel of interest (to be hereinafter described as a local region; a region of 3 pixels×3 pixels here) using a 3×3 coefficient matrix operator called the Sobel operator.

Then, with regard to each pixel for which the gradient has been obtained, the gradient value is compared to a determination threshold value to determine whether or not the pixel of interest is an edge, and binarization for indicating an edge or a non-edge is performed. (Step 13)

For example, binarization can be performed such that 1 is used if an edge is determined, and 0 is used if a non-edge is determined. In this way, an image indicating edges can be acquired correspondingly with the original image.

### SUMMARY OF INVENTION

### Technical Problem

The existing edge detection as described above is effective when the gradients of the luminance values are large in the local region including the pixel of interest. However, it is difficult to detect edges when there are small differences in the luminance values.

As an example of edge detection, it is assumed here that edge detection is performed on an image in which only a ground, a structure, and a blue sky are photographed.

FIG. 2 is a drawing illustrating an example of an edge image of ideal edge detection results.

In the drawing, 20 indicates an image, 21 indicates a blue sky, 22 indicates a structure, 23 indicates a ground, 24 indicates (an edge corresponding to) a boundary between the structure and the sky, 25 indicates an edge corresponding to a projected portion of the structure, and 26 and 27 indicate surfaces of the structure.

In order to facilitate understanding, the drawing illustrates an example where the structure 22 has a simple shape like a rectangular parallelepiped, and the surfaces 26 and 27 are visible on the image.

In the drawing, the edge 24 separating the structure 22 which is an object and the blue sky 21 which is a non-object is successfully detected, and the edge 25 at the projected portion of the structure 22 itself is also successfully detected.

In such a case as FIG. 2, the luminance values often vary greatly between the object (structure) 22 and the blue sky 21. In this case, it is often relatively easy to detect the edge 24 corresponding to the boundary between the object and the blue sky.

When the luminance values vary greatly in the surroundings of the object (structure) 22, not being limited to the case of the blue sky 21, it is relatively easy to detect an edge corresponding to a boundary between the object and the surroundings.

On the other hand, it is often difficult to detect an edge corresponding to a recessed or projected portion of the object itself, compared with such a case as the boundary between the structure 22 and the sky described above.

In FIG. 2, the surface 26 and the surface 27 of the object (structure) 22 are visible. If the surfaces 26 and 27 are constructed of the same material or have the same surface coloring, it is likely that there are small differences in the luminance values between the surface 26 and the surface 27. This is because it is not often the case with a structure, such as a building or a house, that its surfaces have varying materials, colorings, and so on.

Thus, the existing edge detection method has a problem in that it is difficult to determine an edge at a boundary between portions of the object 22 itself, such as the edge 25 which is the boundary between the surface 26 and the surface 27.

FIG. 3 is a drawing illustrating an example of an edge image of inadequate edge detection results. FIG. 3 is to be interpreted in substantially the same manner as FIG. 2.

In the drawing, it can be seen that the edge 25 corresponding to the boundary between the surface 26 and the surface 27 of the object (structure) 22 is not detected. In this case, there is a problem in that the surface 26 and the surface 27 are detected as one surface.

Thus, there has been a problem in that it is not possible to perform various applied technologies using edge detection with sufficient accuracy, such as (1) identification of an object by comparison between a three-dimensional model and an edge image described in Patent Literature 1 above, and (2) creation of a three-dimensional model described in Patent Literature 2.

The present invention has been made to solve the above-described problems, and aims to provide an edge detection apparatus, an edge detection method, and a program that are capable of improving the rate of detection of edges even when there are small variations in image information, such as luminance values, within an image.

### Solution to Problem

An edge detection apparatus according to the present invention includes:

a first processing unit to obtain a variation direction of a pixel value in a first pixel block, using pixel values of a plurality of pixels in a first local region including the first pixel block of an image;

a second processing unit to obtain a variation direction of a pixel value at a pixel in a second pixel block which is different from the first pixel block, using pixel values of a plurality of pixels in a second local region including the second pixel block; and

a third processing unit to determine that the first pixel block is an edge if a difference between the variation direction of the pixel value at a pixel in the first pixel block obtained by the first processing unit and the variation direction of the pixel value at the pixel in the second pixel block obtained by the second processing unit is greater than or equal to a reference value.

An edge detection method according to the present invention includes:

obtaining a variation direction of a pixel value in a first pixel block, using pixel values of a plurality of pixels in a first local region including the first pixel block of an image;

obtaining a variation direction of a pixel value at a pixel in a second pixel block which is different from the first pixel block, using pixel values of a plurality of pixels in a second local region including the second pixel block; and

determining that the first pixel block is an edge if a difference between the variation direction of the pixel value at a pixel by the first pixel block obtained in the first processing unit and the variation direction of the pixel value at the pixel in the second pixel block obtained by the second processing unit is greater than or equal to a reference value.

A program according to the present invention causes a computer to function as an edge detection apparatus in order to detect an edge in an image,

the edge detection apparatus including:

a first processing unit to obtain a variation direction of a pixel value in a first pixel block, using pixel values of a plurality of pixels in a first local region including the first pixel block of the image;

a second processing unit to obtain a variation direction of a pixel value at a pixel in a second pixel block which is different from the first pixel block, using pixel values of a plurality of pixels in a second local region including the second pixel block; and
a third processing unit to determine that the first pixel block is an edge if a difference between the variation direction of the pixel value at a pixel in the first pixel block obtained by the first processing unit and the variation direction of the pixel value at the pixel in the second pixel block obtained by the second processing unit is greater than or equal to a reference value.

### Advantageous Effects of Invention

According to an edge detection apparatus of the present invention, it is possible to provide an edge detection apparatus, an edge detection method, and a program that are capable of improving the rate of detection of edges even for an image having small variations in image information within the image.

### BRIEF DESCRIPTION OF DRAWINGS

FIG. 1 is a drawing illustrating an overview of a process flow of an edge detection method by the Canny method which is an existing technique;

FIG. 2 is a drawing illustrating an example of an edge image of ideal edge detection results;

FIG. 3 is a drawing illustrating an example of an edge image of inadequate edge detection results;

FIG. 4 is a drawing illustrating an overview of an internal configuration of an edge detection apparatus in a first embodiment of the present embodiment;

FIG. 5 is a drawing illustrating an overview of a process flow of the edge detection apparatus in the first embodiment of the present invention;

FIG. 6 is a drawing illustrating an example of a distribution of luminance values in a local region in the first embodiment of the present invention;

FIG. 7 is a drawing illustrating a correspondence relation between a frequency spectrum of pixel values and a variation direction in the first embodiment of the present invention;

FIG. 8 is a drawing illustrating an example of a distribution of variation directions of luminance values in one image in the first embodiment of the present invention;

FIG. 9 is a drawing illustrating an example of directions of recessed and projected portions of an object in the first embodiment of the present invention;

FIG. 10 is a drawing illustrating an overview of an internal configuration of an edge detection apparatus in a second embodiment of the present invention;

FIG. 11 is a drawing illustrating an overview of a process flow of the edge detection apparatus in the second embodiment of the present invention;

FIG. 12 is a drawing illustrating an overview of a process flow of an edge detection apparatus in a third embodiment of the present invention;

FIG. 13 is a drawing illustrating an overview of an internal configuration of an edge detection apparatus in a fourth embodiment of the present invention;

FIG. 14 is a drawing illustrating an overview of a process flow of the edge detection apparatus in the fourth embodiment of the present invention;

FIG. 15 is a drawing illustrating an example of an image taken by an imaging apparatus while moving in the fourth embodiment of the present invention;

FIG. 16 is a drawing illustrating an example of a frequency spectrum in the fourth embodiment of the present invention; and

FIG. 17 is a drawing illustrating an overview of an internal configuration of an edge detection apparatus in a fifth embodiment of the present invention.

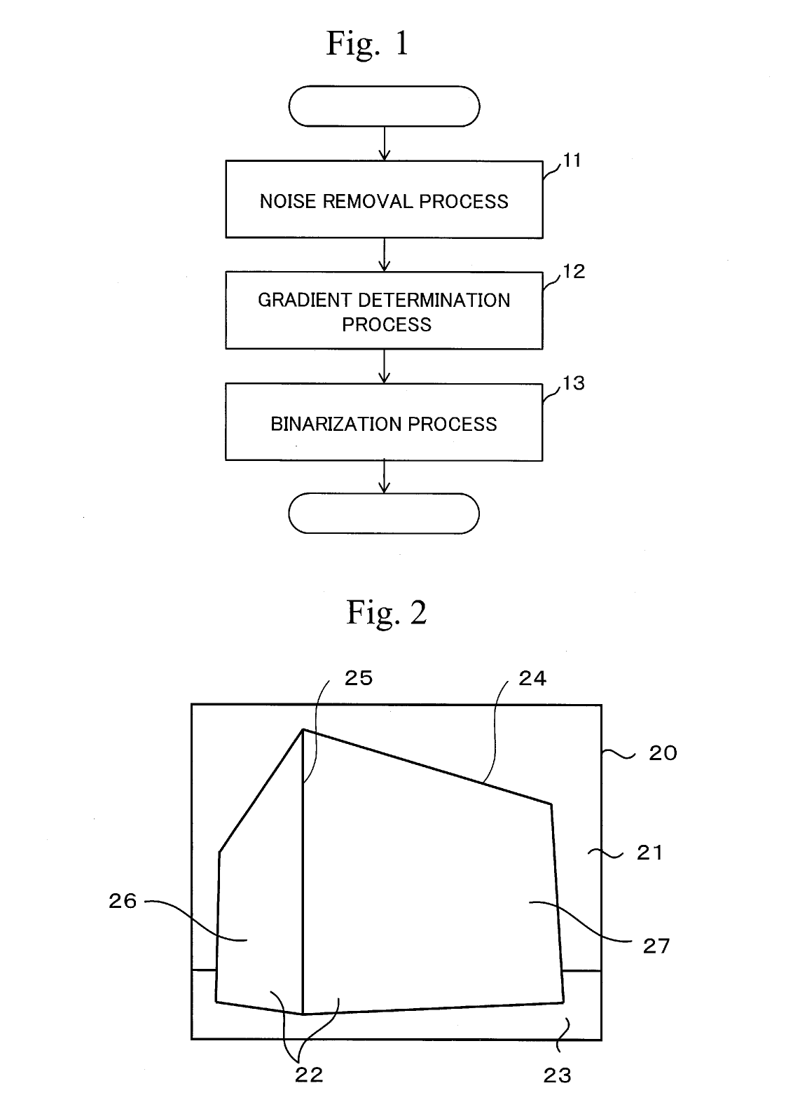

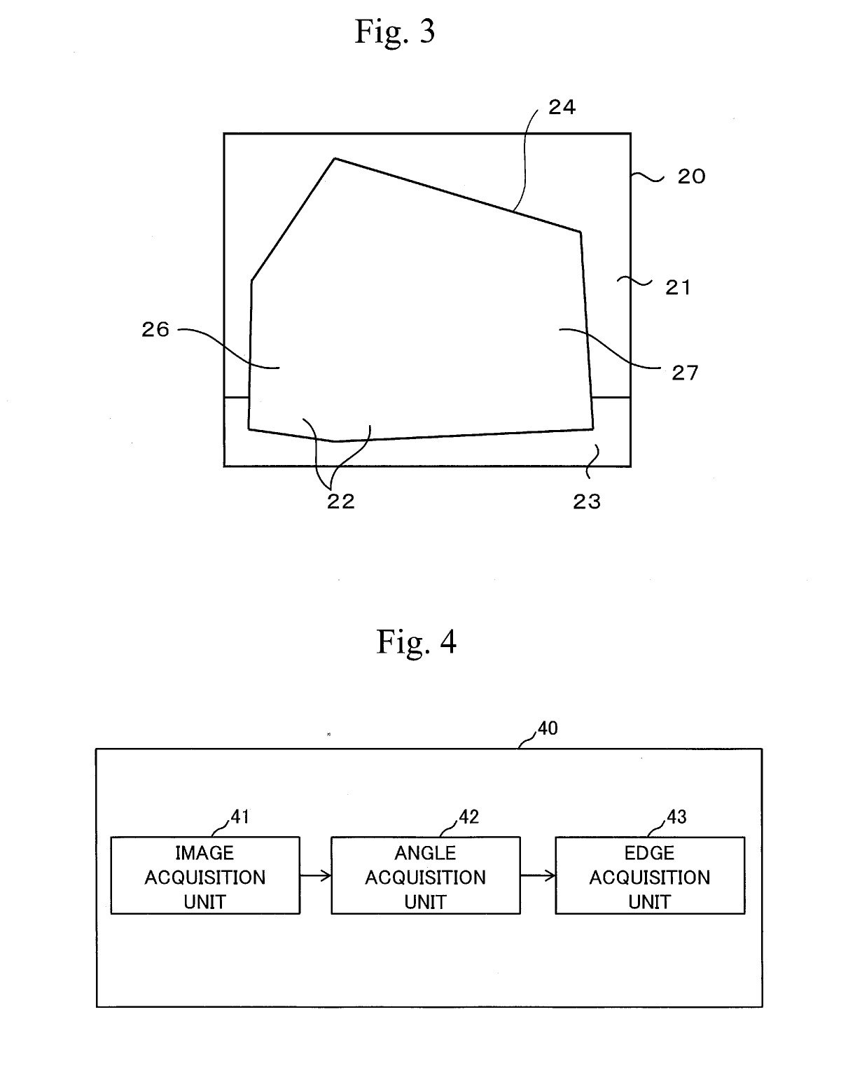

### DESCRIPTION OF EMBODIMENTS

Embodiments of the present invention will be described hereinafter with reference to the drawings.

In the drawings of the following embodiments, the same or substantially the same parts are given the same or substantially the same numerals, and description thereof may be partially omitted in the description of the embodiments.

Elements in the drawings are divided for convenience of describing the present invention, and forms of implementation thereof are not limited to configurations, divisions, names, and so on in the drawings. How the divisions are made is also not limited to the divisions illustrated in the drawings.

In the following description, a “unit” may be replaced with “means”, a “device”, a “processing apparatus”, a “functional module”, or the like.

### First Embodiment

A first embodiment of the present invention will be described hereinafter with reference to FIG. 4 to FIG. 9.

In order to facilitate understanding of the description without loss of generality, this embodiment will be described using, as an example, a case where (1) an image signifies a two-dimensional image composed of a plurality of pixels and defined by “width×height”, and (2) an edge detection process is performed on one image.

FIG. 4 is a drawing illustrating an overview of an internal configuration of an edge detection apparatus in the first embodiment of the present invention.

In the drawing, 40 indicates the edge detection apparatus, 41 indicates an image acquisition unit, 42 indicates an angle acquisition unit (first and second processing units), and 43 indicates an edge acquisition unit (third processing unit).

The image acquisition unit 41 acquires image information of an image to be the subject of the edge detection process.

The image information may include information representing shades and so on of the image at each pixel (to be hereinafter described as a pixel value), and may also include various types of information on the image. A value representing (1) luminance or (2) color may be used as a pixel value, for example.

A pixel value can be represented using various representation methods. For example, (1) RBG representation or (2) YCbCr representation can be used.

Various methods can be applied as a method for acquiring the image information. For example, the following can be applied: (1) a method in which the image information of a photographed image is acquired from an imaging apparatus, such as a camera, or (2) a method in which the image information of an image saved in a storage medium is read and acquired.

The image acquisition unit 41 can be implemented in various implementation arrangements. For example, the following can be applied: (1) an arrangement including an imaging apparatus such as a camera, (2) an arrangement including an input interface for acquiring image information from the outside of the edge detection apparatus, or (3) an arrangement including an input interface for acquiring image information from storage means which is incorporated or can be incorporated in the edge detection apparatus.

The angle acquisition unit (first and second processing units) 42 obtains a variation direction of a pixel value on a per-pixel-block basis, based on the image information acquired by the image acquisition unit 41.

It is assumed herein that a pixel block includes at least one pixel. A local region may include a surrounding pixel of a corresponding pixel block.

Specifically, the angle acquisition unit 42 obtains a variation direction of a pixel value relating to a first pixel block, using pixel values of a plurality of pixels in a first local region including the first pixel block. (First processing unit)

The angle acquisition unit 42 also obtains a variation direction of a pixel value relating to a pixel in a second pixel block, using pixel values of pixels in a second local region including the second pixel block which is different from the first pixel block.

### Second Processing Unit

Various methods can be applied as a method for setting (deciding) the number of pixels in a pixel block and the number of pixels in a local region. For example, the following can be applied: (1) a method in which these are set in the apparatus in advance, (2) a method in which these are set from the outside of the apparatus, (3) these are decided in the apparatus, or (4) a combination of some or all of (1) to (3).

An example of a method for obtaining a variation direction of a pixel value will be described in an overview of a process flow to be described later.

The edge acquisition unit (third processing unit) 43 obtains an edge from information on the variation directions of the pixel values acquired by the angle acquisition unit (first and second processing units) 42.

Specifically, the first pixel block is determined to be an edge if a difference between the variation direction of the pixel value at the pixel in the first pixel block and the variation direction of the pixel value at the pixel in the second pixel block acquired by the angle acquisition unit (first and second processing units) 42 is greater than or equal to a reference value.

Next, an overview of the process flow for edge detection will be described.

In order to facilitate understanding of the description without loss of generality, the following description will be provided using, as an example, a case where (1) a luminance value of an image is used as the pixel value corresponding to each pixel, and (2) a variation direction of a luminance value is obtained on a per-pixel basis, that is, the number of pixels in one pixel block is one.

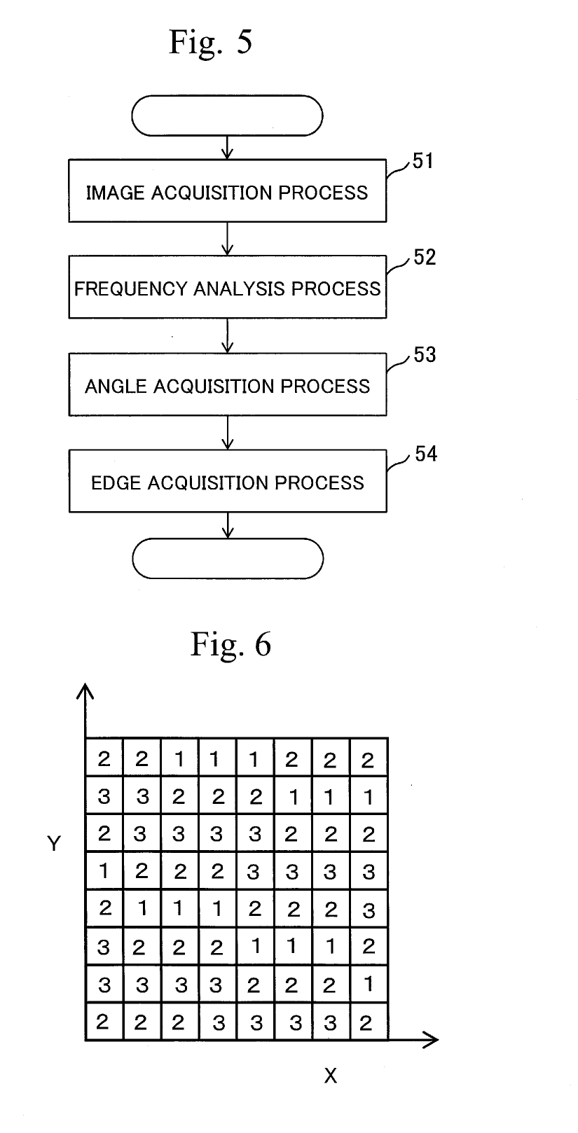

FIG. 5 is a drawing illustrating an overview of the process flow of the edge detection apparatus in the first embodiment of the invention.

In the drawing, 51 indicates an image acquisition process, 52 indicates a frequency analysis process, 53 indicates an angle acquisition process, and 54 indicates an edge acquisition process. The top of the drawing indicates the start of the process flow, and the bottom of the drawing indicates the end of the process flow.

First, the image acquisition unit 41 acquires image information of an image to be the subject of the edge detection process. (Step 51)

Then, the angle acquisition unit 42 performs a frequency analysis, which is known as a spatial frequency analysis, based on the image information acquired by the image acquisition unit 41 and using luminance values of a plurality of pixels included in a local region, and thereby obtains a frequency spectrum. (Step 52)

Specifically, since this description assumes that the number of pixels in one pixel block is one, first to perform a frequency analysis on a given pixel to be looked at (pixel of interest), the frequency analysis is performed using luminance values of pixels in the local region including the pixel of interest. Then, the pixel of interest is sequentially changed to perform a frequency analysis similarly also on other pixels.

The details of the frequency analysis and an example of the analysis will be described later, together with how to obtain a variation direction.

Various methods can be applied to obtain a luminance value. For example, the following can be applied: (1) a method in which the image acquisition unit 41 acquires a luminance value as a part of the image information itself, and the angle acquisition unit 42 acquires it from the image acquisition unit 41, (2) a method in which a luminance value is obtained in the image acquisition unit 41 from the image information acquired by the image acquisition unit 41, and the angle acquisition unit 42 obtains it from the image acquisition unit 41, or (3) a method in which the angle acquisition unit 42 acquires the acquired image information from the image acquisition unit 41, and the angle acquisition unit 42 obtains a luminance value.

Then, the angle acquisition unit 42 obtains variation directions of the luminance values on a per-pixel basis, based on the frequency spectrum obtained by the frequency analysis in step 52. (Step 53)

The details and an example of how to obtain a variation direction will be described later.

The value of a variation direction is represented in (1) degree measure or (2) circular measure, for example.

Then, the edge acquisition unit 43 determines whether or not a given pixel is an edge, based on a distribution of the variation directions of the luminance values obtained in step 53. (Step 54)

Specifically, the variation direction of the luminance value relating to the pixel of interest (first pixel) is compared with the variation direction of the luminance value relating to a pixel (second pixel) which is different from the pixel of interest. If a direction difference is greater than or equal to a reference value (threshold value), the pixel of interest is determined to be an edge.

Various methods can be applied as a method for comparing the variation directions and a method for implementation thereof For example, the following can be applied: (1) a method of comparison by an absolute value of a direction difference or (2) a method of comparison by direction and size.

This embodiment will be described using, as an example, a case where the pixel (second pixel) which is different from the pixel of interest and used for comparison is a pixel adjacent to the pixel of interest (first pixel).

Then, the pixel of interest is changed sequentially, and comparison is performed similarly also with regard to other pixels.

The term “comparison” is used as a concept including (1) comparing the variation directions of the luminance values directly, (2) obtaining a difference between the variation directions of the luminance values to check whether the difference is positive or negative, and so on. A method for implementation is not limited, provided that a comparison operation is achieved in practical terms.

Various methods for implementation can be applied as an arrangement for implementation of information indicating an edge or a non-edge. For example, the following can be applied: (1) an edge is determined if the direction difference is greater than the reference value, (2) a non-edge is determined if the direction difference is smaller than the reference value, (3) different values (for example, 0 and 1) are used for an edge and a non-edge, or the like.

The reference value for edge detection needs to be defined before the edge detection process (step 54).

This reference value indicates a sensitivity of edge detection in this embodiment.

By setting a small angle, for example 15 degrees (represented in degree measure), as the reference value, a greater number of edges are detected. However, it is more likely that a pixel which is not an edge is determined to be an edge because of the effects of noise.

On the other hand, when a large angle, for example 60 degrees, is set as the reference value, the effects of noise can be reduced. However, it is more likely that a pixel which should be determined to be an edge is determined to be a non-edge.

As countermeasures against this, for example, the following process flow may be applied: the reference value is adjusted based on a result of edge detection of the present invention according to the type of the image to be detected, and so on, and (1) the edge detection process is performed again or (2) the entire detection process is repeated. With this arrangement, a more optimal reference value can be used.

Examples of a frequency analysis, a distribution of variation directions of luminance values, and edge detection will now be described with reference to the drawings.

FIG. 6 is a drawing illustrating an example of a distribution of luminance values in a given local region in the first embodiment of the present invention.

Being the distribution of the luminance values, it corresponds to a distribution of shades relating to brightness of the image.

In the drawing, a cell represents each pixel in the local region, a number in the cell represents a luminance value, and X and Y represent expediential coordinates for indicating the position of each pixel in the two-dimensional image.

FIG. 6 indicates an example where the size of the local region, that is, the number of pixels in the local region, is 8×8. It is assumed that the number 1 is the brightest and the number 3 is the darkest in the drawing.

As can be seen from the drawing, it can be seen that major variations exist in a direction from the bottom left to the top right (or in a direction from the top right to the bottom left) in this local region.

It can also be seen that a cycle of variations in a Y direction is shorter than a cycle of variations in an X direction. Therefore, when a frequency analysis is performed, frequencies of frequency spectrum components corresponding to major variation components become smaller than frequencies of major frequency spectrum components of variations in the Y direction.

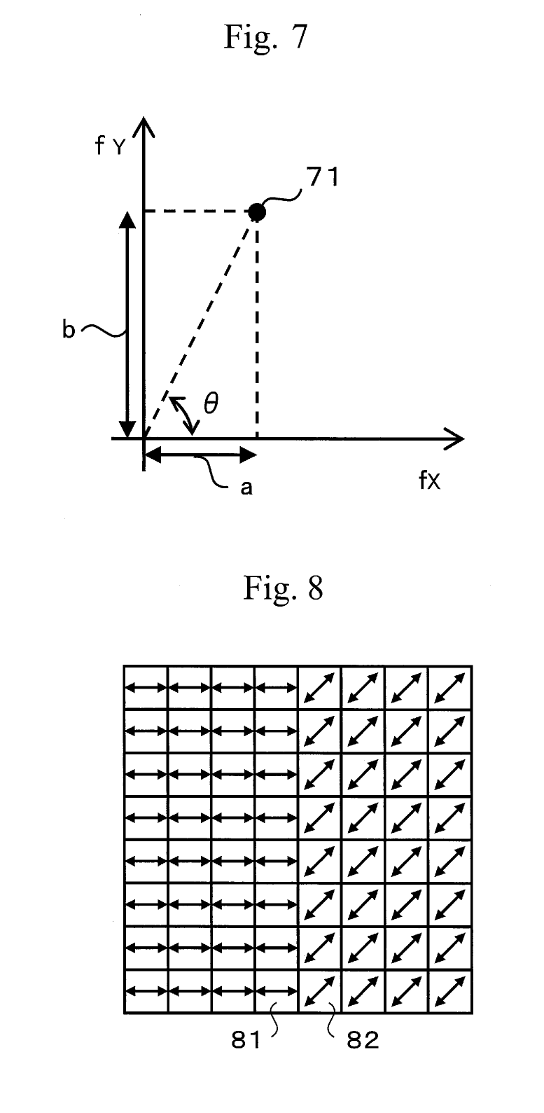

FIG. 7 is a drawing illustrating a correspondence relation between a frequency spectrum of pixel values (luminance values) and a variation direction in the first embodiment of the present invention. FIG. 7 is a drawing illustrating the relation between the frequency spectrum obtained from the distribution of the pixel values (luminance values) in the local region illustrated as an example in FIG. 6, that is, the local region specified with respect to a given pixel of interest, and the variation direction at the pixel of interest.

When a frequency analysis is performed, it is less likely that there is one frequency spectrum component, and more likely that a plurality of frequency spectrum components are acquired. To facilitate understanding of the description, only a frequency component 71 corresponding to a peak is illustrated as the frequency spectrum herein.

In the drawing, a longitudinal axis indicates frequencies in a lateral direction (X direction), a longitudinal axis indicates frequencies in a longitudinal direction (Y direction), 71 indicates a frequency spectrum position with a peak amplitude out of the frequency spectrum obtained as a result of the frequency analysis, and θ indicates a direction of the frequency spectrum 71 with the peak amplitude.

In FIG. 7, the position of the peak of the frequency spectrum is located at a distance of “a” in the fX direction and at a distance of “b” in the fY direction. The angle θ of the peak is obtained from these “a” and “b”, and the angle θ is regarded as the variation direction of the luminance value.

As described above, the variation direction θ of the luminance value is obtained according to the major variations in the distribution of the luminance values as illustrated as an example in FIG. 6.

When there exist a plurality of frequency spectrum peaks, various methods can be applied to select a frequency spectrum with which the variation direction θ is obtained. For example, the following can be applied: (1) a method in which the maximum peak is used for an image with little noise, or (2) a method in which a position at the midpoint between peaks is used as the peak for an image with much noise.

In the case of (1) above, highly accurate edge detection results can be obtained. In the case of (2), it is considered that there may be effects of noise when the maximum peak is used, but the effects of noise can be reduced by applying a process flow which is modified such that a position at the midpoint between peaks is used as the peak.

The variation directions θ of the luminance values on a per-pixel basis acquired by the angle acquisition unit 42 can be associated with the pixels of the original image, and can be regarded as an image indicating a distribution of the variation directions of the luminance values (to be hereinafter described as an angle image).

The pixel value of each pixel in the angle image is the variation direction θ of the pixel value at the pixel position corresponding to the input image, and this value is represented in degree measure or circular measure, for example.

FIG. 8 is a drawing illustrating an example of a distribution of variation directions θ of luminance values (angle image) in the first embodiment of the present invention. That is, FIG. 8 is a drawing illustrating an angle image indicating the distribution of the variation directions θ of the luminance values obtained for each pixel of an image which is the subject of the edge process. To facilitate understanding, the variation directions θ are represented by arrows.

In the drawing, a cell represents each pixel in the image, an arrow in the cell indicates a variation direction of a luminance value, 81 indicates a pixel of interest, and 82 indicates a pixel adjacent to the pixel of interest (to be hereinafter described as an adjacent pixel).

The drawing illustrates an example where the variation directions θ of the luminance values are obtained with regard to the image having 8×8 (=64) pixels.

It is assumed that the specified reference value is, for example, 30 degrees (degree measure).

It can be seen from the drawing that a difference between the variation direction of the pixel of interest 81 and the variation direction of the adjacent pixel 82 in the drawing is not less than 30 degrees. Accordingly, the edge acquisition unit 43 determines that the pixel 81 is an edge.

Similarly, by changing the pixel of interest sequentially, a plurality of pixels located above the pixel 81 and the pixel 82 in the drawing are determined to be edges.

Various pixels can be used as the pixel to be compared with the pixel of interest (pixel 81 in the drawing). For example, (1) the pixel of interest may be compared with each of four adjacent pixels above, below, on the left, and on the right, or (2) the pixel of interest may be compared with each of eight pixels also including adjacent pixels in a diagonal direction. In the case of (1), both of the pixel 81 and the pixel 82 are determined to be edges.

Information indicating an edge or a non-edge which is obtained by the edge acquisition unit 43 can be associated with the pixels of the original image, and can be regarded as an image indicating a distribution of edges (to be hereinafter described as an edge image). The edge image is a binary image indicating whether each pixel is an edge or a non-edge.

With an actual image, for example, in which an object is a man-made object, it is generally often the case that linear features of pixel values exist on the surfaces of the object in the image.

With a structure, for example, there exist columns arranged regularly, joints between members, beams, decorations provided at each boundary between floors, a window, and a balcony (these that exist on the surfaces of the object will be hereinafter described as surface features).

The arrangement rules of these surface features tend not to vary greatly on a given surface of the object.

For example, a window, a balcony, or the like of a structure is generally placed in the horizontal direction, and this horizontal angle rarely changes in the middle of a given surface.

It is often the case with a structure that the arrangement rules of surface features are standardized on a plurality of surfaces of the structure.

As described above, the arrangement of surface features often has linear features, so that a linear direction, that is, an angle of the surface features can be obtained by reading the luminance values of the image. Therefore, it is possible to obtain the directions in which the variations of the luminance values appear on the image in accordance with the surface features.

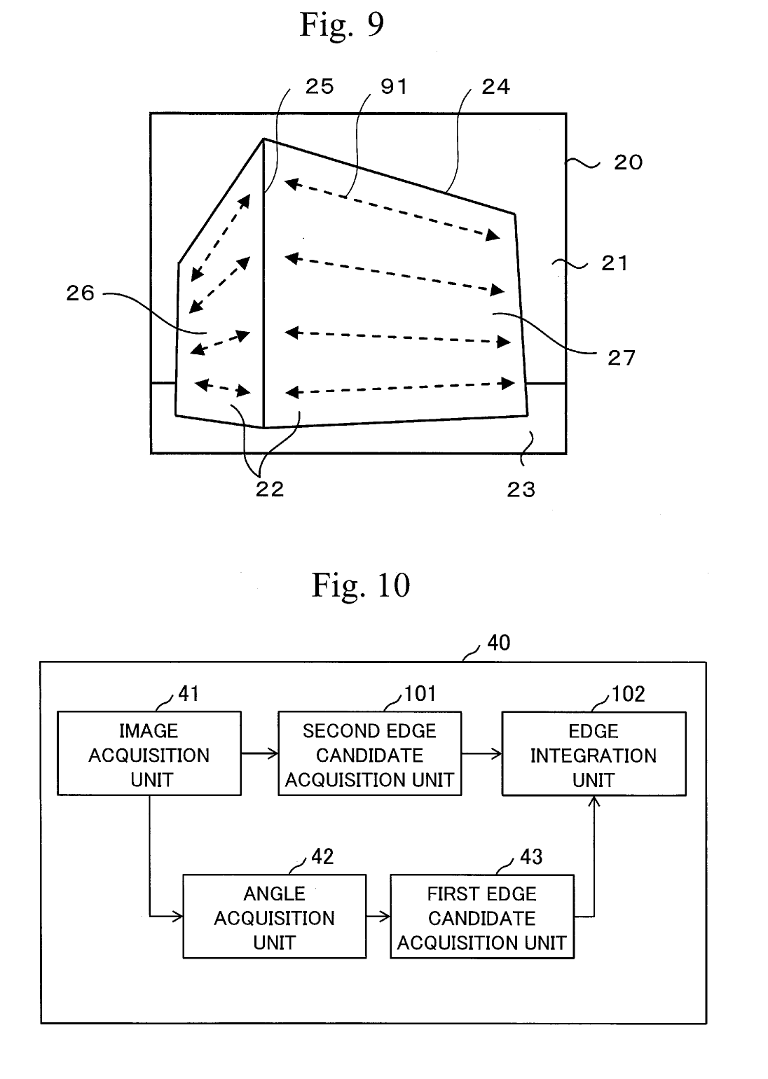

FIG. 9 is a drawing illustrating an example of variation directions of recessed and projected portions of an object in the first embodiment of the present invention.

FIG. 9 is an image which is substantially the same as FIG. 2, and is to be interpreted in substantially the same manner as FIG. 2.

In the drawing, 91 (dashed-dotted-line arrows) indicates directions of surface features of a structure.

As can be seen from FIG. 9, the directions of the surface features vary greatly in the vicinity of an edge 25 which is a boundary between a surface 26 and a surface 27.

By performing a frequency analysis, calculation of the variation directions θ of the luminance values on a per-pixel basis, and edge detection, as described above, also for the boundary portion between the surface 26 and the surface 27, detection of the edge 25 corresponding to the boundary between the surface 26 and the surface 27 is facilitated even when a difference in the luminance values between the surface 26 and the surface 27 is not large.

As described above, according to the edge detection apparatus and the edge detection method of this embodiment, it is possible to provide an edge detection apparatus, an edge detection method, and a program that are capable of improving the edge detection rate even for an image having image information with small variations within the image.

It is also possible to create a three-dimensional model from an image and identify an object by comparing the three-dimensional model and an edge image, with high accuracy.

In this embodiment, the description is provided for the case where a frequency analysis is performed using the local region whose size is 8×8 (see FIG. 6). However, various sizes can be applied as the size of the local region. For example, (1) 16×16 or (2) 32×32 may be applied. The size of the local region may be a fixed value or a variable value.

When the size of the local region is larger, variations of pixel values in a larger range can be extracted, and the effects of noise can also be reduced.

In this embodiment, the width of a detected edge is a width equal to two pixels (see the pixel 81 and the pixel 82 of FIG. 8). However, many applications using edge detection results assume that the width of a detected edge is a width equal to one pixel.

In that case, the apparatus may be configured such that after the variation directions θ of the pixel values are obtained in the angle acquisition unit 42, (1) the pixel of interest is compared only with the pixels on the left and above, or (2) an edge thinning process is performed after step 54, for example. The apparatus and the process flow are not limited to those in the drawings described above.

Various existing and new methods can be applied as the thinning process.

In this embodiment, a frequency analysis is performed on a per-pixel basis to obtain a direction on a per-pixel basis. However, a pixel block may include a plurality of pixels, and a frequency analysis may be performed on a per-pixel-block basis to obtain variation directions of pixel values on a per-pixel-block basis.

In this case, the pixel block may be the same size as the local region, that is, the local region may include no surrounding pixel.

In this case, the variation direction θ acquired for the pixel block may be regarded as the variation direction of every pixel in the pixel block.

When an analysis is performed on a basis of a range including a plurality of pixels as described above, the accuracy of edge detection results is reduced. However, the amount of arithmetic operations required for processing can be reduced.

When a frequency analysis is performed on a per-pixel-block basis, if it is necessary to match the size of an angle image with the size of the original image, an interpolation process may be performed on the obtained angle image after angles are obtained.

Existing and new methods for interpolation can be applied as the method for interpolation. For example, the following existing methods can be applied: (1) nearest-neighbor interpolation, (2) linear interpolation, or (3) bicubic interpolation.

Among (1) to (3) above, nearest-neighbor interpolation allows for high-speed processing, although the accuracy of interpolation is relatively not high. Linear interpolation or bicubic interpolation allows for highly accurate interpolation, although the amount of arithmetic operations is increased and thus the processing speed is relatively low.

This embodiment assumes that variation directions are obtained for all the pixels in the image. However, it is not necessarily required to obtain variation directions for all the pixels in the image, and variation directions may be obtained for some of the pixels in the image.

The sizes of a pixel, a pixel block, and a local region at an end portion of the image may be different from those at a portion other than the end portion.

In the description of FIG. 5 of this embodiment, a frequency analysis is performed for all the pixels which require a frequency analysis in the frequency analysis in step 52, and then angles are obtained in step 52. However, it is not limited to the above description, provided that the same result is obtained in step 54. For example, it may be arranged that (1) steps 52 and 53 are performed on a given pixel, and then steps 52 and 53 are performed similarly on another pixel, (2) steps 52 to 54 are performed on a set of pixels required for determining an edge or a non-edge, and then steps 52 to 54 are performed on another set of pixels, or (3) a plurality of divided regions are processed in parallel.

### Second Embodiment

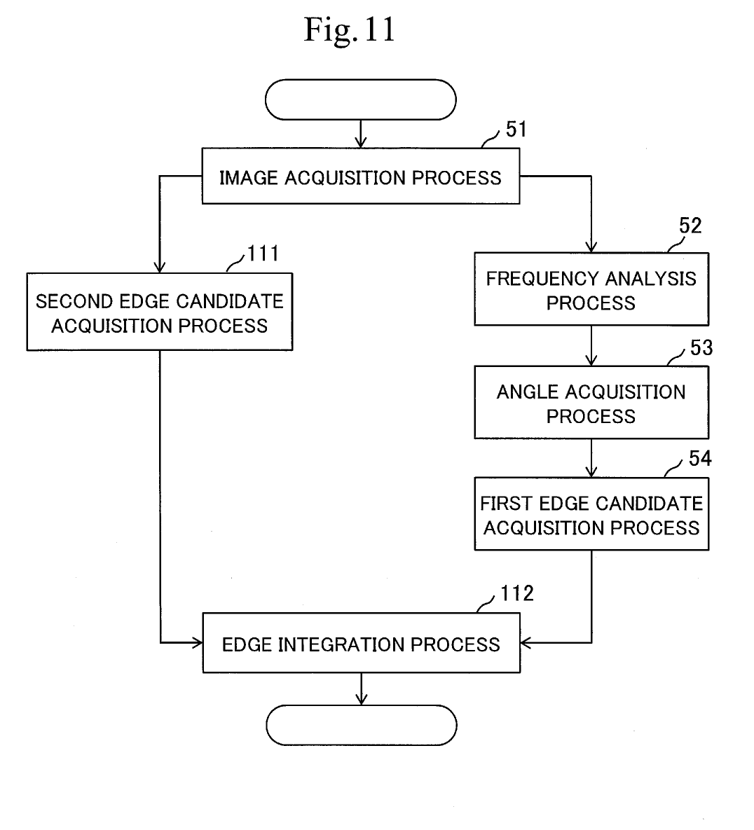

A second embodiment of the present invention will be described hereinafter with reference to FIG. 10 and FIG. 11.

With regard to component elements and operation which are substantially the same as the internal configuration and operation of the edge detection apparatus of the first embodiment above, description thereof may be omitted.

FIG. 10 is a drawing illustrating an overview of an internal configuration of an edge detection apparatus in a modification in the second embodiment of the present invention.

In the drawing, 40 indicates the edge detection apparatus, 41 indicates an image acquisition unit, 42 indicates an angle acquisition unit (first and second processing units), 43 indicates a first edge candidate acquisition unit (third processing unit), 101 indicates a second edge candidate acquisition unit (fourth processing unit), and 102 indicates an edge integration unit.

The main differences from FIG. 4 of the embodiment above are that the edge acquisition unit (third processing unit) 43 is replaced with the first edge candidate acquisition unit, and the second edge candidate acquisition unit (fourth processing unit) 101 and the edge integration unit 102 are added.

The first edge candidate acquisition unit (third processing unit) 43 performs substantially the same process as that of the edge acquisition unit (third processing unit) 43 of the first embodiment above.

However, a detection result is regarded as an edge candidate (first edge candidate).

The second edge candidate acquisition unit (fourth processing unit) 101 acquires, from the image acquisition unit 41, image information on the same image as the image acquired by the edge acquisition unit (third processing unit) 43 of the first embodiment above.

Note that a part of the image information to be used may be different depending on the content of each process.

The second edge candidate acquisition unit (fourth processing unit) 101 performs an edge detection process by an edge detection method which is different from the edge process of the first embodiment above, based on the image information acquired by the image acquisition unit 41.

A detection result of the second edge candidate acquisition unit (fourth processing unit) 101 is regarded as a second edge candidate.

Various existing and new methods for detection can be applied as a method for detecting an edge candidate in the second edge candidate acquisition unit (fourth processing unit) 101. For example, a method for detection based on the size of the gradient of a pixel value can be applied.

For example, (1) the Canny method or (2) the Laplacian method can be applied as the method for detection based on the size of the gradient of a pixel value.

The edge integration unit 102 obtains an edge based on the edge candidate (first edge candidate) acquired by the first edge candidate acquisition unit (third processing unit) 43 and the edge candidate (second edge candidate) acquired by the second edge candidate acquisition unit (fourth processing unit) 101.

Next, an overview of a process flow for edge detection will be described.

FIG. 11 is a drawing illustrating an overview of the process flow of the edge detection apparatus in the modification in the second embodiment of the present invention.

In the drawing, 51 indicates an image acquisition process, 52 indicates a frequency analysis process, 53 indicates an angle acquisition process, 54 indicates a first edge candidate acquisition process, 111 indicates a second edge candidate acquisition process, and 112 indicates an edge integration process. The top of the drawing indicates the start of the process flow, and the bottom of the drawing indicates the end of the process flow.

The first edge candidate acquisition unit (third processing unit) 43 performs substantially the same process as the edge acquisition unit (third processing unit) 43 of the first embodiment above, based on the image information acquired by the image acquisition unit 41. A detection result is regarded as a first edge candidate.

A distribution of first edge candidates can be regarded as a first edge candidate image.

The second edge candidate acquisition unit (fourth processing unit) 101 performs an edge detection process by an edge detection method which is different from that of the first edge candidate acquisition unit (third processing unit) 43, based on the same image information as the image information acquired by the image acquisition unit 41. A detection result is regarded as a second edge candidate.

Next, the differences from the first embodiment above in the overview of the process flow for edge detection will be mainly described. It is assumed that a luminance value is used as a pixel value as in the embodiment above.

The second edge candidate acquisition unit (fourth processing unit) 101 applies the edge detection method which is different from the edge process (step 52 to step 54) of the first embodiment above to the image information acquired from the image acquisition unit 41, and thereby obtains a second edge candidate. (Step 111)

A distribution of second edge candidates can be regarded as a second edge candidate image.

The edge integration unit 102 obtains an edge (edge image) based on the edge candidate (first edge candidate) acquired by the first edge candidate acquisition unit (third processing unit) 43 and the edge candidate (second edge candidate) acquired by the second edge candidate acquisition unit (fourth processing unit) 121. (Step 112)

It is not required that the first edge candidate acquired by the first edge candidate acquisition unit (third processing unit) 43 and the second edge candidate obtained by the second edge candidate acquisition unit (fourth processing unit) 121 match completely with each other in terms of attributes relating to edge candidates, such as (1) the size of an edge image and (2) the width of an edge.

When two edge candidate images indicate an edge or a non-edge on a per-pixel basis, for example, the edge integration unit 102 compares the two pixels at the corresponding position in the original image.

In obtaining an edge, if either or both of the pixels are edge candidates, the pixel at this position is determined to be an edge. That is, only if both of the pixels are non-edges, a non-edge is determined. In this case, this can be done easily by a logical sum (OR) of the values indicating an edge or a non-edge.

Alternatively, for example, the edge integration unit 102 may determine an edge only if both of the two corresponding edge pixels are edge candidates. In this case, this can be done easily by a logical product (AND) of the values indicating an edge or a non-edge.

As described above, according to the edge detection apparatus and the edge detection method of this embodiment, substantially the same effects as those of the first embodiment above are achieved.

By a combination with the edge detection process by the process method different from that of the embodiment above, different edge images can be obtained and the efficiency of detection of edges can be improved further.

In substantially the same process as that in the first embodiment above, various sizes can be applied as the size of the local region. The size of the local region may be a fixed value or a variable value.

In substantially the same process as that in the first embodiment above, the edge detection apparatus may be configured to perform the thinning process on edge candidates.

In substantially the same process as that in the first embodiment above, a pixel block may include a plurality of pixels, and a frequency analysis may be performed on a per-pixel-block basis to obtain variation directions of pixel values on a per-pixel-block basis. While doing that, the interpolation process may be performed on the obtained angle image as in the first embodiment above.

In substantially the same process as that in the first embodiment above, it is not necessarily required to obtain variation directions for all the pixels in the image, and variation directions may be obtained for some of the pixels in the image.

In substantially the same process as that in the first embodiment above, the sizes of a pixel, a pixel block, and a local region at an end portion of the image may be different from those at a portion other than the end portion.

In substantially the same process as that in the first embodiment above, various modifications of the process flow are possible as in the first embodiment above.

Further, in FIG. 10 and FIG. 11 of this embodiment, the flow indicates that the first and second edge candidates are obtained in parallel. However, it is sufficient that the first and second edge candidates have been obtained when an edge is finally to be obtained (step 112), and the sequence of the process flow is not limited to that in the drawings.

### Third Embodiment

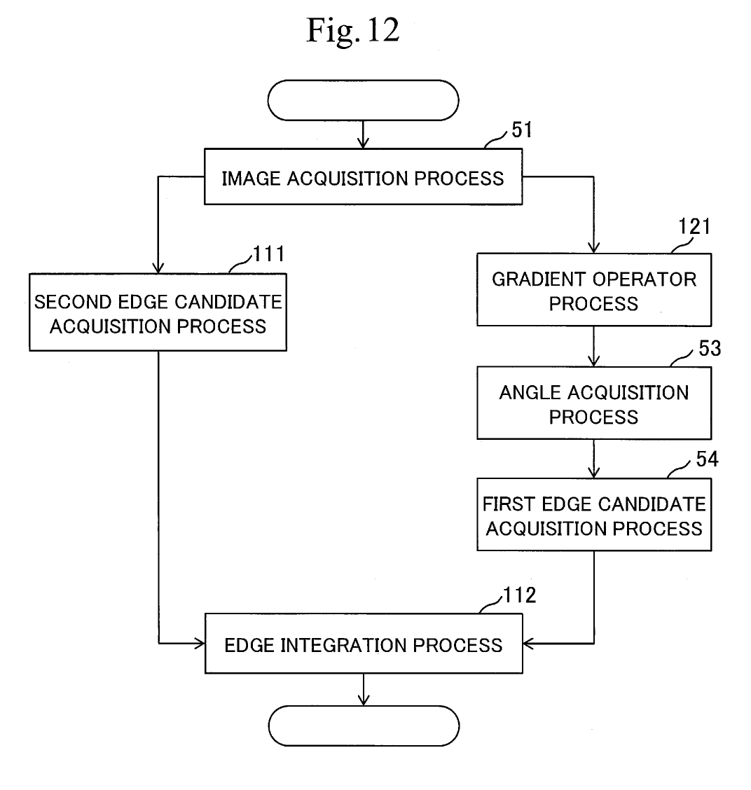

A third embodiment of the present invention will be described hereinafter with reference to FIG. 12.

With regard to component elements that are the same or substantially the same as the component elements of the first embodiment above, description thereof may be omitted.

FIG. 12 is a drawing illustrating an overview of a process flow of an edge detection apparatus in the third embodiment of the present invention.

In the drawing, 51 indicates an image acquisition process, 53 indicates an angle acquisition process, 54 indicates a first edge candidate acquisition process, 111 indicates a second edge candidate acquisition process, 112 indicates an edge integration process, and 121 indicates a gradient operator process. The top of the drawing indicates the start of the process flow, and the bottom of the drawing indicates the end of the process flow.

An overview of an internal configuration of the edge detection apparatus is substantially the same as FIG. 10 of the second embodiment above.

The difference from the process flow of FIG. 11 of the second embodiment is that the gradient operator process 121 is included in place of the frequency analysis process 52.

The angle acquisition unit (first and second processing units) 42 obtains variation directions θ of pixel values on a per-pixel-block basis, based on the image information acquired by the image acquisition unit 41. (Step 121 to step 53)

Specifically, an operator to obtain a gradient of a pixel value is applied first. (Step 121)

Existing and new operators can be applied as the operator to obtain the gradient of the pixel value. For example, (1) the Sobel operator or (2) the Prewitt operator can be applied.

When the Sobel operator or the Prewitt operator is used, the operator is applied to a local region whose size is 3×3 and whose center is the pixel of interest.

Then, the angle acquisition unit (first and second processing units) 42 obtains the variation directions of the luminance values on a per-pixel basis, based on the gradient amount in each direction obtained by applying the gradient operator described above. (Step 53)

A variation direction can be obtained by an inverse trigonometric function, based on the gradient size in a horizontal direction and the gradient size in a vertical direction. Specifically, for example, the gradient in the horizontal direction is obtained by a gradient operator for the horizontal direction, and the gradient in the vertical direction is obtained by a gradient operator for the vertical direction. A variation direction can be obtained by the inverse trigonometric function using the obtained gradients in these directions.

As described above, according to the edge detection apparatus and the edge detection method of this embodiment, substantially the same effects as those of the second embodiment above are achieved.

Compared with the second embodiment above, the variation directions of the pixel values can be obtained at high speed.

This is because in the second embodiment the frequency analysis, such as the Fourier transform, is used and thus many floating-point operations are used in the implementation of the apparatus, but when the operator is applied, the implementation can be realized with sum-of-products operations on integers and thus the scale of circuitry can be reduced and the processing speed can be enhanced.

With regard to substantially the same configuration and operation as those of the second embodiment above, various modifications are possible as in the second embodiment above.

### Fourth Embodiment

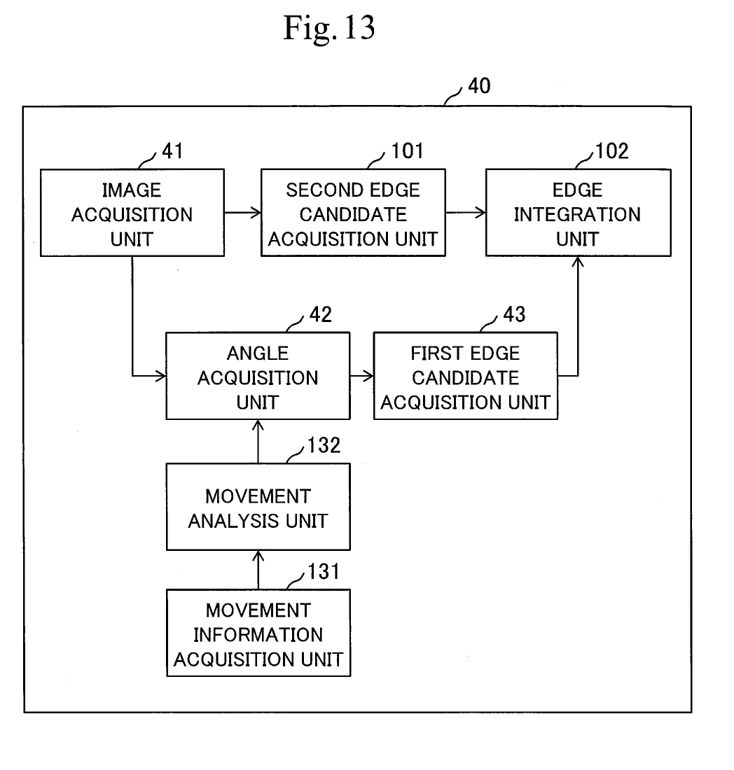

A fourth embodiment of the present invention will be described hereinafter with reference to FIG. 13 to FIG. 16.

With regard to component elements that are the same or substantially the same as the component elements of the embodiments above, description thereof may be omitted.

FIG. 13 is a drawing illustrating an overview of an internal configuration of an edge detection apparatus in the fourth embodiment of the present invention.

In the drawing, 40 indicates the edge detection apparatus, 41 indicates an image acquisition unit, 42 indicates an angle acquisition unit (first and second processing units), 43 indicates a first edge candidate acquisition unit (third processing unit), 101 indicates a second edge candidate acquisition unit (fourth processing unit), 102 indicates an edge integration unit, 131 indicates a movement information acquisition unit, and 132 indicates a movement analysis unit.

The main difference from FIG. 10 of the second embodiment is that the movement information acquisition unit 131 and the movement analysis unit 132 are added.

In this embodiment, it is assumed that the image acquisition unit 41 can recognize a movement situation (including a stationary state) of an imaging apparatus (not illustrated) such as a camera.

The movement information acquisition unit 131 recognizes the movement situation of the imaging apparatus, and obtains information on the movement of the imaging apparatus (to be hereinafter described as movement information).

Various types of information can be applied as the movement information, provided that the information allows the movement situation of the imaging apparatus to be recognized. For example, (1) the acceleration of the imaging apparatus, (2) the velocity of the imaging apparatus, or (3) the position of the imaging apparatus can be applied.

Various methods for implementation can be applied for a method for recognizing the movement situation. For example, when the acceleration is used for recognizing the movement situation, an acceleration sensor is included in (or integrated with) the image acquisition unit 41, and the following can be applied: (1) a method in which an acceleration signal is output and the movement information acquisition unit 131 acquires the acceleration signal and recognizes the movement situation, or (2) a method in which the acceleration signal is converted into movement information in the image acquisition unit 41 and the movement information acquisition unit 131 acquires the movement information and recognizes the movement situation.

The definition of the movement information acquisition unit 131 may include a sensor which is used to acquire the movement information.

The movement analysis unit 132 analyzes components that are problematic in obtaining variation directions θ, out of changes in pixel values occurring on a photographed image as a result of movement of the imaging apparatus, based on the movement information of the imaging apparatus acquired by the movement information acquisition unit 131.

These components in this embodiment will be described in a process flow to be described later.

The angle acquisition unit 42 obtains variation directions θ of pixel values by excluding the components caused by movement or based on components that are not affected by movement, based on a result of analysis by the movement analysis unit 132.

Next, an overview of an example of the process flow for edge detection will be described.

In the following description, the description will be provided using, as an example, a case where information on the acceleration when the imaging apparatus moves is acquired as the movement information.

In this embodiment, the movement analysis unit 132 obtains frequency spectrum components corresponding to a residual image generated as a result of movement, as the components resulting from movement.

How to obtain a frequency spectrum resulting from a residual image will be described later.

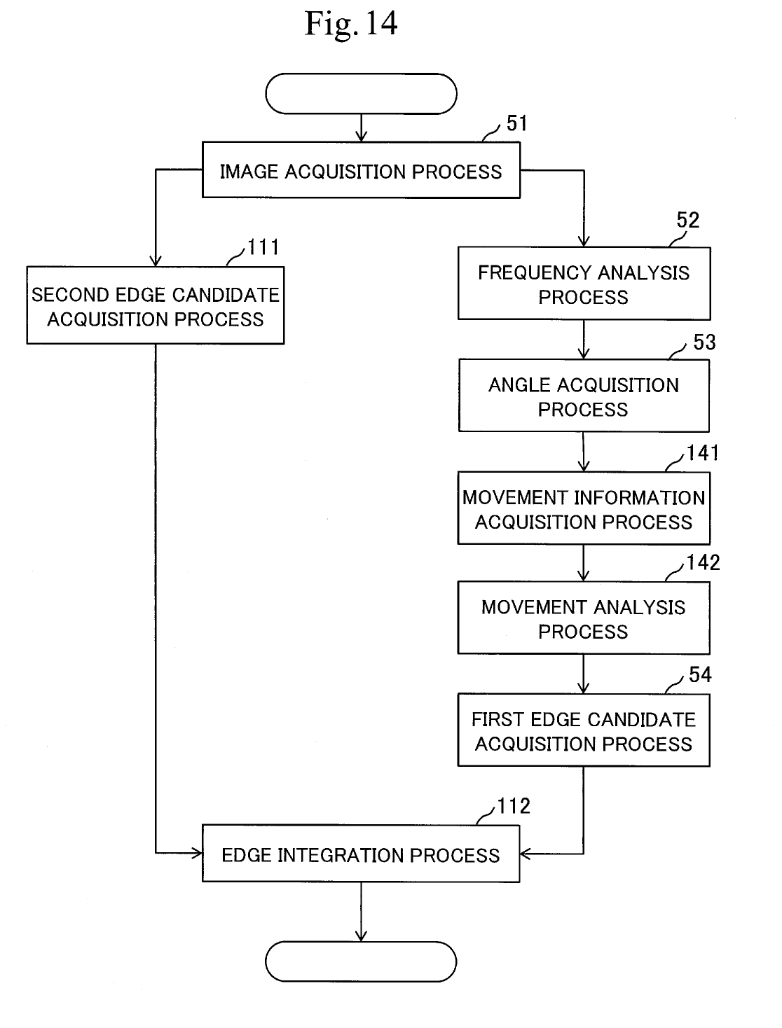

FIG. 14 is a drawing illustrating an overview of the process flow of the edge detection apparatus in the fourth embodiment of the present invention.

In the drawing, 51 indicates an image acquisition process, 52 indicates a frequency analysis process, 53 indicates an angle acquisition process, 54 indicates a first edge candidate acquisition process, 111 indicates a second edge candidate acquisition process, 112 indicates an edge integration process, 141 indicates a movement information acquisition process, and 142 indicates a movement analysis process. The top of the drawing indicates the start of the process flow, and the bottom of the drawing indicates the end of the process flow.

The difference from FIG. 11 of the second embodiment is that the movement information acquisition process 141 and the movement analysis process 142 are added between the frequency analysis process 52 and the angle acquisition process 53.

First, the angle acquisition unit 42 performs a frequency analysis using luminance values of a plurality of pixels included in a local region based on image information acquired by the image acquisition unit 41, and thereby obtains a frequency spectrum. (Step 52)

Then, the movement information acquisition unit 131 recognizes the movement situation of the imaging apparatus, and obtains movement information. (Step 141)

Then, the movement analysis unit 132 obtains frequency spectrum components corresponding to a residual image pattern generated on the image as a result of movement of the imaging apparatus, based on the frequency spectrum acquired by the angle acquisition unit 42 and the movement information acquired by the movement information acquisition unit 131. (Step 142)

As long as the movement information and the frequency spectrum components resulting from the residual image by the movement analysis unit 132 have been obtained when variation directions of pixel values are to be obtained, the sequence and timing of the processes is not limited to those in the drawing.

The angle acquisition unit 42 identifies the frequency spectrum components corresponding to the residual image pattern out of the frequency spectrum obtained by the frequency analysis in step 52.

The frequency spectrum components corresponding to the residual image may be identified or estimated, and may be obtained taking into consideration a possibility of being generated by the residual image.

The angle acquisition unit 42 obtains variation directions θ of luminance values by excluding the frequency spectrum components corresponding to the residual image, or based on components which are not affected by movement.

There is a possibility that the effects of the residual image on the image vary depending on the subject that is photographed, for example. Thus, a possibility that a frequency spectrum component peak is generated by the residual image may be taken into consideration in obtaining the variation directions.

It is not necessarily required to consider all the frequency spectrum components corresponding to the residual image. Major components may be selected as appropriate.

An example of exclusion of the frequency spectrum components resulting from movement will now be described.

Normally, while the imaging apparatus is moving, a residual image is generated on an image of an imaging result except for the case where the shutter time of the imaging apparatus is sufficiently short or a compensation process such as image stabilization is implemented.

This residual image is generated in the same direction as the vanishing point in the movement direction. Thus, when the variation directions are obtained in the angle calculation unit 42, there is a possibility that the direction of the residual image has an impact.

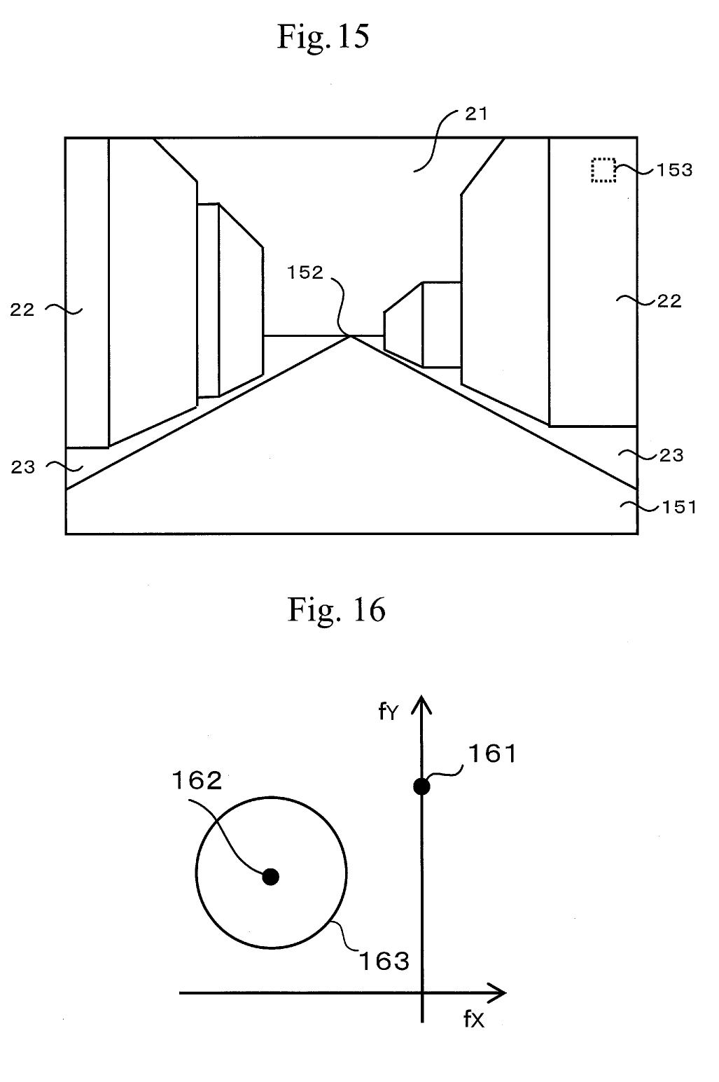

FIG. 15 is a drawing illustrating an example of an image taken by the imaging apparatus while moving in the fourth embodiment of the present invention.

In the drawing, 21 indicates a blue sky, 22 indicates a structure, 23 indicates a ground, 151 indicates a road, 152 indicates a vanishing point, and 153 indicates a range of a given pixel block (or local region).

It is assumed that the imaging apparatus is moving on the road 151 toward the vanishing point.

In light of the range 153 of the pixel block (or local region) to be looked at, since the imaging apparatus is moving toward the vanishing point, there is a possibility that a residual image is generated along the direction toward the vanishing point 152.

FIG. 16 is a drawing illustrating an example of a frequency spectrum corresponding to the range 153 of the given pixel block (or local region). The drawing is to be interpreted in substantially the same manner as FIG. 7.

In the drawing, 161 indicates a frequency spectrum component peak of an object itself, 162 indicates a frequency spectrum component peak generated by a residual image, and 163 indicates a neighborhood range centered at the peak 162.

In a case such as that described in the drawing, there is a possibility that the accuracy of detecting edges of the object is reduced when the residual image has a significant impact, such as when the size of the peak 162 is greater than the size of the peak 161.

In such a case, the angle acquisition unit 42 obtains the variation direction θ after excluding the peak 162.

As described above, substantially the same effects as those of the second embodiment are achieved.

An increase in false detection of edges can be prevented when an image is acquired while the imaging apparatus is moving, such as when the imaging apparatus takes an image while being attached to a portable device or an automobile.

With regard to substantially the same configuration and operation as those of the embodiments above, various modifications are possible as in the embodiments above.

In this embodiment, the frequency spectrum peak component 162 which is generated or may be generated as a result of movement of the imaging apparatus is excluded. In an actual image, however, a plurality of frequency spectrum components are often generated in the neighborhood of the peak 162, and thus frequency spectrum components in the neighborhood range 163 may also be excluded.

### Fifth Embodiment

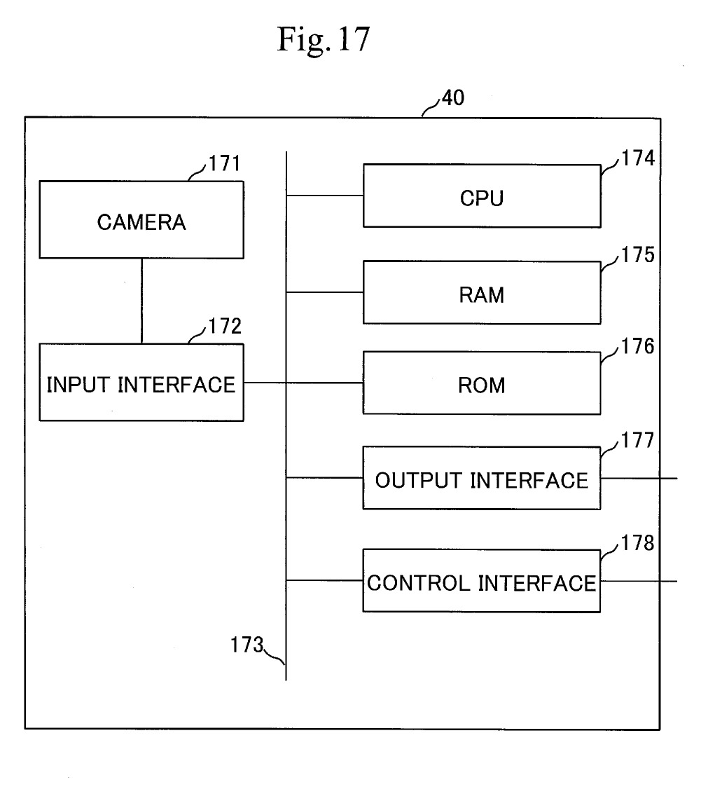

A fifth embodiment of the present invention will be described hereinafter with reference to FIG. 17.

With regard to substantially the same elements and functions as those in the configuration of the first embodiment above, description thereof may be omitted.

FIG. 17 is a drawing illustrating an overview of an internal configuration of an edge detection apparatus in the fifth embodiment of the present invention.

In the drawing, 171 indicates a camera, 172 indicates an input interface, 173 indicates a bus, 174 indicates a CPU (Central Processing Unit), 175 indicates a RAM (Random Access Memory), 176 indicates a ROM (Read Only Memory), 177 indicates an output interface, and 178 indicates a control interface.

It is possible to define the edge detection apparatus in a limited sense as not including the camera 171, for example. It is also possible to define the edge detection apparatus in a broad sense as including other component elements which are not illustrated, such as (1) a power supply and (2) a display device.

The camera 171 generates image information.

The input interface 172 acquires the image information from the camera 171.

When the edge detection apparatus 40 not including the camera 171 is assumed, the image information is input from the outside of the edge detection apparatus 40. In that case, the input interface 172 may be implemented as what is known as a connector, for example.

The bus 173 connects the component elements.

The CPU 174 performs various processing, such as (1) arithmetic processing and (2) control processing.

The RAM 175 and the ROM 176 store various types of information.

The output interface 177 outputs various types of information to the outside of the edge detection apparatus 40.

The control interface 178 exchanges control information with the outside of the edge detection apparatus 40.

In this embodiment, the component elements illustrated in FIG. 17 correspond to some or all of the component elements of the embodiments above.

For example, mainly the camera 171 and the input interface 172 may correspond to either or both of the image acquisition unit 41 and the movement information acquisition unit 131.

For example, mainly the CPU 174 may correspond to some or all of the angle acquisition unit (first and second processing units) 42, the edge acquisition unit (third processing unit) 43, the first edge candidate acquisition unit (third processing unit) 43, the second edge candidate acquisition unit (fourth processing unit) 101, the edge integration unit 102, and the movement analysis unit 132.

An overview of the operation of the edge detection apparatus is substantially the same as that in the embodiments above, and thus description thereof will be omitted.

As described above, according to the edge detection apparatus and the edge detection method of this embodiment, substantially the same effects as those of the embodiments above are achieved, correspondingly to the embodiments above.

The CPU 174 in FIG. 17 of this embodiment is described simply as a CPU in the description of the drawing. However, as long as it can realize processing functions typified by arithmetic operations or the like, it may be (1) a microprocessor, (2) an FPGA (Field Programmable Gate Array), (3) an ASIC (Application Specific Integrated Circuit), or (4) a DSP (Digital Signal Processor), for example.

Processing may be any of (1) analog processing, (2) digital processing, and (3) a combination of both types of processing. Further, (1) implementation by hardware, (2) implementation by software (program), (3) implementation by a combination of both, and so on are possible.

The RAM 175 in this embodiment is described simply as a RAM in the description of the drawing. However, as long as data can be stored and held in a volatile manner, it may be (1) an SRAM (Static RAM), (2) a DRAM (Dynamic RAM), (3) an SDRAM (Synchronous DRAM), or (4) a DDR-SDRAM (Double Data Rate SDRAM), for example.

Also note that (1) implementation by hardware, (2) implementation by software, (3) implementation by a combination of both, and so on are possible.

The ROM 176 in this embodiment is described simply as a ROM in the description of the drawing. However, as long as data can be stored and held, it may be (1) an EPROM (Electrical Programmable ROM) or (2) an EEPROM (Electrically Erasable Programmable ROM), for example. Also note that implementation by hardware, implementation by software, implementation by a combination of these, and so on are possible.

In the embodiments above, the case where a luminance value is used as a pixel value has been described. However, a pixel value is not limited to a luminance value.

For example, with a color image, (1) the present invention may be applied by using one of components constituting a color space such as RGB, HSV, or YCbCr as a pixel value, or (2) the present invention may be applied on a per-component basis.

In the second and subsequent embodiments above, one type of detection of a first edge candidate based on variation directions of pixel values is combined with another type of detection of a second edge candidate by a different method. However, it may be configured to use a plurality of types of detection methods, not being limited to the embodiments above.

The drawings presented in the embodiments above are drawings in which detailed functions, internal structures, and so on are omitted in order to facilitate understanding of the description. Therefore, the configuration and implementation of the processing apparatus of the present invention may include functions or component elements other than the functions or component elements illustrated in the drawings, such as display means (function) and communication means (function).

How the configurations, functions, and processes of the apparatus are divided in the embodiments above is an example. In the implementation of the apparatus, it is sufficient that equivalent functions can be realized, and the implementation of the apparatus is not limited to the embodiments above.

The content of a signal and information carried by an arrow connecting a unit with another unit in the drawings may vary depending on how division is made. In that case, the signal and information carried by the arrow or line may have different information attributes, such as (1) whether or not the implementation is explicit and (2) whether or not the information is specified explicitly.

For each process or operation in the embodiments above, various modifications are possible within the scope of the problems and effects of the present invention. Each process or operation may be (1) implemented by being modified to a substantially equivalent (or corresponding) process (or operation), or (2) implemented by being divided into a plurality of substantially equivalent processes. Also, (3) a process which is common to a plurality of blocks may be implemented as a process of a block including these blocks, or (4) implemented collectively by one of the blocks.

### REFERENCE SIGNS LIST

11: image acquisition process, 12: gradient acquisition process, 13: binarization process, 20: image, 21: sky, 22: structure, 23: ground, 24 and 25: edges, 25 and 26: surfaces of the structure, 40: edge detection apparatus, 41: image acquisition unit, 42: angle acquisition unit (first and second processing units), 43: edge acquisition unit (third processing unit) or first edge candidate acquisition unit, 51: image acquisition process, 52: frequency region analysis process, 53: angle acquisition process, 54: edge acquisition process, 71: frequency spectrum peak, 81 and 82: pixels, 91: surface features, 101: second edge candidate acquisition unit, 102: edge integration unit, 111: existing method process, 113: edge integration process, 121: gradient operator process, 131: movement information acquisition unit, 132: movement analysis unit, 141: movement information acquisition process, 142: movement analysis process, 151: road, 152: vanishing point, 153: range of a given pixel block (or local region), 161 and 162: frequency spectrum peaks, 163: neighborhood of the peak 162, 171: camera, 172: input interface, 173: bus, 174: CPU, 175: RAM, 176: ROM, 177: output interface, and 178: control interface

1-8. (canceled)

9. An edge detection apparatus to detect an edge in an image acquired by an imaging apparatus, the edge detection apparatus comprising:
a first processing unit to apply a frequency analysis to pixel values of a plurality of pixels in a first local region including a first pixel block of the image, obtain a frequency component generated by movement of the imaging apparatus while acquiring the image, out of frequency components acquired by the frequency analysis, using information on a movement situation of the imaging apparatus, and obtain a variation direction of a pixel value in the first pixel block based on a frequency component other than the frequency component generated by the movement of the imaging apparatus;
a second processing unit to apply a frequency analysis to pixel values of a plurality of pixels in a second local region including a second pixel block which is different from the first pixel block, obtain a frequency component generated by the movement of the imaging apparatus while acquiring the image, out of frequency components acquired by the frequency analysis, using the information on the movement situation of the imaging apparatus, and obtain a variation direction of a pixel value in the second pixel block based on a frequency component other than the frequency component generated by the movement of the imaging apparatus; and
a third processing unit to determine that the first pixel block is an edge if a difference between the variation direction of the pixel value in the first pixel block obtained by the first processing unit and the variation direction of the pixel value in the second pixel block obtained by the second processing unit is greater than or equal to a reference value.

10. The edge detection apparatus according to claim 9, further comprising:
a fourth processing unit to detect an edge in the image by a processing method which is different from processes in the first processing unit, the second processing unit, and the third processing unit, wherein
the edge detected by the third processing unit is used as a first edge candidate, and the edge detected by the fourth processing unit is used as a second edge candidate, and an edge is obtained using the first edge candidate and the second edge candidate.

11. The edge detection apparatus according to claim 9, wherein
each of the first pixel block and the second pixel block includes a plurality of pixels, and
an identical direction is used as the variation direction of the pixel value in each pixel block for every pixel within each pixel block.

12. An edge detection method to detect an edge in an image acquired by an imaging apparatus, the edge detection method comprising:
applying a frequency analysis to pixel values of a plurality of pixels in a first local region including a first pixel block of the image, obtaining a frequency component generated by movement of the imaging apparatus while acquiring the image, out of frequency components acquired by the frequency analysis, using information on a movement situation of the imaging apparatus, and obtaining a variation direction of a pixel value in the first pixel block based on a frequency component other than the frequency component generated by the movement of the imaging apparatus, in a first processing unit;
applying a frequency analysis to pixel values of a plurality of pixels in a second local region including a second pixel block which is different from the first pixel block, obtaining a frequency component generated by the movement of the imaging apparatus while acquiring the image, out of frequency components acquired by the frequency analysis, using the information on the movement situation of the imaging apparatus, and obtaining a variation direction of a pixel value in the second pixel block based on a frequency component other than the frequency component generated by the movement of the imaging apparatus, in a second processing unit; and
determining that the first pixel block is an edge if a difference between the variation direction of the pixel value in the first pixel block obtained by the first processing unit and the variation direction of the pixel value in the second pixel block obtained by the second processing unit is greater than or equal to a reference value, in a third processing unit.

13. A non-transitory computer readable medium storing a program to cause a computer to function as an edge detection apparatus in order to detect an edge in an image acquired by an imaging apparatus,
the edge detection apparatus comprising:
a first processing unit to apply a frequency analysis to pixel values of a plurality of pixels in a first local region including a first pixel block of the image, obtain a frequency component generated by movement of the imaging apparatus while acquiring the image, out of frequency components acquired by the frequency analysis, using information on a movement situation of the imaging apparatus, and obtain a variation direction of a pixel value in the first pixel block based on a frequency component other than the frequency component generated by the movement of the imaging apparatus;
a second processing unit to apply a frequency analysis to pixel values of a plurality of pixels in a second local region including a second pixel block which is different from the first pixel block, obtain a frequency component generated by the movement of the imaging apparatus while acquiring the image, out of frequency components acquired by the frequency analysis, using the information on the movement situation of the imaging apparatus, and obtain a variation direction of a pixel value in the second pixel block based on a frequency component other than the frequency component generated by the movement of the imaging apparatus; and
a third processing unit to determine that the first pixel block is an edge if a difference between the variation direction of the pixel value in the first pixel block obtained by the first processing unit and the variation direction of the pixel value in the second pixel block obtained by the second processing unit is greater than or equal to a reference value.
